(19) United States
(12) Patent Application Publication
(10) Pub. No.: US 2022/0225582 A1
(43) Pub. Date: Jul. 21, 2022

(54) Insect Barrier Assembly

(71) Applicant: Robert Gaxiola, Ontario, CA (US)

(72) Inventor: Robert Gaxiola, Ontario, CA (US)

(21) Appl. No.: 17/151,984

(22) Filed: Jan. 19, 2021

(51) Int. Cl. A01G 13/10; F16B 2/12

(52) U.S. Cl. CPC A01G 13/105; F16B 2/12

(57) ABSTRACT

An insect barrier assembly for inhibiting crawling insects from climbing a trunk of a tree includes a pair of first shells that is each removably attached together to form a closed ring around the trunk of the tree. Each of the first shells is concavely hollow thereby facilitating each of the first shells to be fillable with water. In this way the first shells inhibit crawling insects from crossing the first shells and subsequently climbing the trunk of the tree. A pair of second shells provided and each of the second shells is removably attached together to form a closed ring around the trunk of the tree.

### CROSS-REFERENCE TO RELATED APPLICATIONS

Not Applicable

### STATEMENT REGARDING FEDERALLY SPONSORED RESEARCH OR DEVELOPMENT Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR Not Applicable

### BACKGROUND OF THE INVENTION

### (1) Field of the Invention

The disclosure relates to barrier devices and more particularly pertains to a new barrier device for inhibiting crawling insects from climbing a trunk of a tree.

### (2) Description of Related Art Including Information Disclosed under 37 CFR 1.97 and 1.98

The prior art relates to barrier devices including a variety of tree protection rings that include a sloped top side to inhibit crawling insects from climbing the trunk of a tree. The prior art discloses a tree protection ring that holds water and that includes a fastener that penetrates the trunk of a tree for attaching the tree protection ring to the trunk of the tree.

### BRIEF SUMMARY OF THE INVENTION

An embodiment of the disclosure meets the needs presented above by generally comprising a pair of first shells that is each removably attached together to form a closed ring around a trunk of a tree. Each of the first shells is concavely hollow thereby facilitating each of the first shells to be fillable with water. In this way the first shells inhibit crawling insects from crossing the first shells and subsequently climbing the trunk of the tree. A pair of second shells provided and each of the second shells is removably attached together to form a closed ring around the trunk of the tree.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an insect barrier assembly according to an embodiment of the disclosure.

FIG. 2 is a bottom view of a pair of first shells of an embodiment of the disclosure showing the first shells forming a closed ring.

FIG. 3 is a bottom view of a pair of second shells of an embodiment of the disclosure showing the second shells being detached from each other.

FIG. 4 is a front view of an embodiment of the disclosure.

FIG. 5 is a cross sectional view taken along line 5-5 of FIG. 1 of an embodiment of the disclosure.

FIG. 6 is a perspective in-use view of an embodiment of the disclosure.

### DETAILED DESCRIPTION OF THE INVENTION

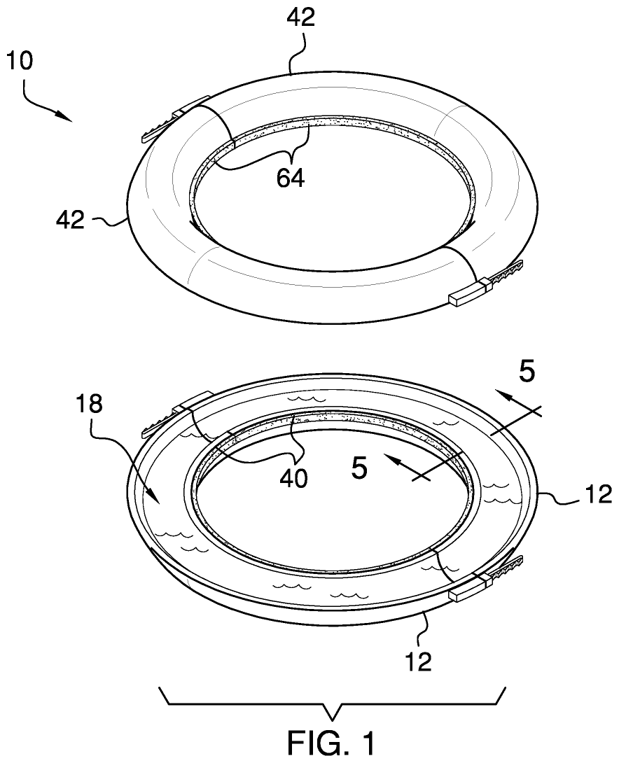

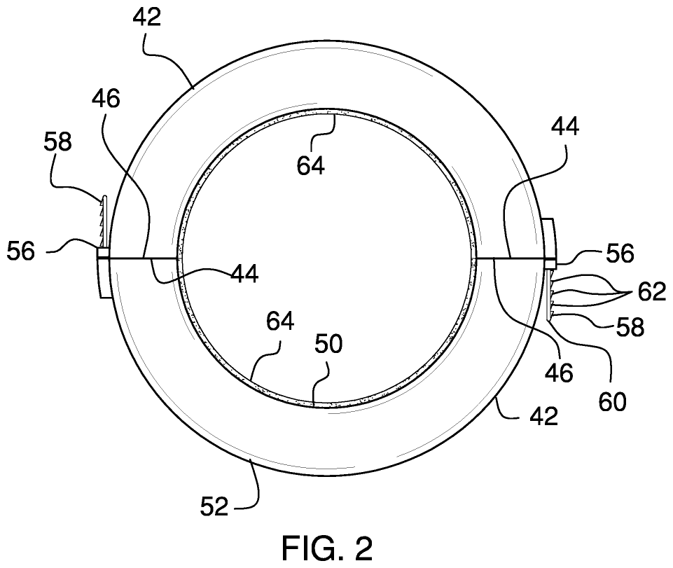

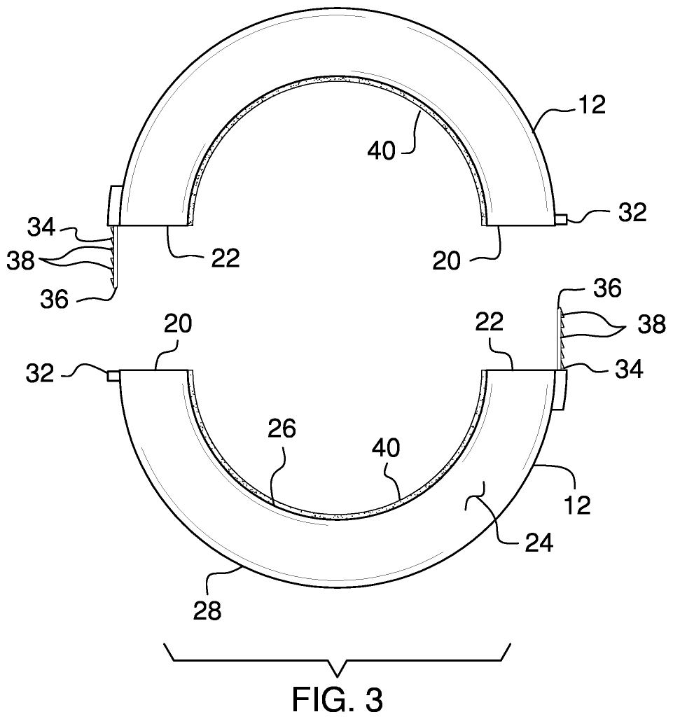

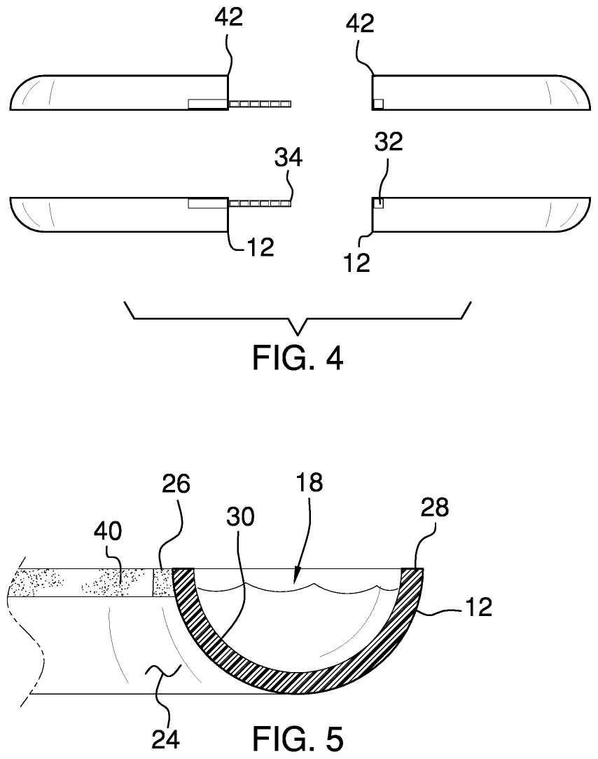

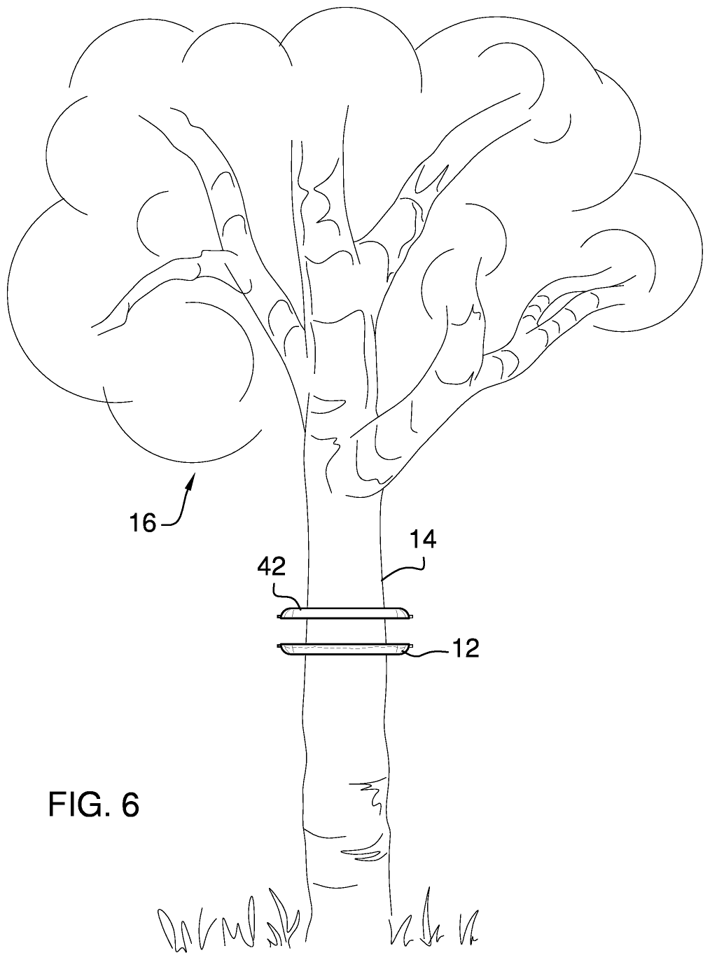

With reference now to the drawings, and in particular to FIGS. 1 through 6 thereof, a new barrier device embodying the principles and concepts of an embodiment of the disclosure and generally designated by the reference numeral 10 will be described.

As best illustrated in FIGS. 1 through 6, the insect barrier assembly 10 generally comprises a pair of first shells 12 that can be removably attached together to form a closed ring. In this way each the first shells 12 can be positioned around a trunk 14 of a tree 16. Each of the first shells 12 is concavely hollow thereby facilitating each of the first shells 12 to be fillable with water 18. In this way the first shells 12 inhibit crawling insects from crossing the first shells 12 and subsequently climbing the trunk 14 of the tree 16. Thus, the crawling insects are inhibited from eating leaves and fruit on the tree 16, thereby enhancing the health of the tree 16.

Each of the first shells 12 has a first end 20, a second end 22 and an outer surface 24 extending therebetween, and each of the first shells 12 has a front edge 26 and a back edge 28 each extending between the first end 20 and the second end 22. Each of the first shells 12 is curved between the first end 20 and the second end 22 such that each of the first shells 12 forms a semi-circle. The outer surface 24 has top side 30 and the top side 30 of the outer surface 24 of each of the first shells 12 is concavely arcuate between the front edge 26 and the back edge 28. Each of the first end 20 and the second end 22 of each of the first shells 12 abuts each other to form the closed ring thereby facilitating the first shells 12 to be positioned around the trunk 14 of the tree 16. Additionally, each of the first end 20 and the second end 22 of each of the first shells 12 may be comprised of a resiliently compressible material thereby facilitating the first end 20 to form a fluid impermeable seal with the second end 22 to inhibit the water 18 from leaking out of the first shells 12. Additionally, each of the first shells 12 may have a width of at least 3.0 inches to ensure insects cannot cross the first shells 12.

A pair of first receivers 32 is each coupled to the first end 20 of a respective one of the first shells 12. A pair of first ratchets 34 is each coupled to the second end 22 of a respective one of the first shells 12. Each of the first ratchets 34 has a distal end 36 with respect to the second end 22 of the respective first shell 12. Moreover, each of the first ratchets 34 has a plurality of teeth 38 extending between the distal end 36 and the second end 22 of the respective first shell 12. Each of the first receivers 32 insertably receives a respective one of the first ratchets 34. Moreover, a respective one of the teeth 38 on each of the first ratchets 34 engages a respective first receiver 32 thereby facilitating an adjustable diameter of the closed ring formed by the first shells 12. In this way the first shells 12 can accommodate a variety of sizes of trunks 14.

A pair of first cushions 40 is provided and each of the first cushions 40 is coupled to a respective one of the first shells 12. Each of the first cushions 40 is aligned with the front edge 26 of the respective first shell 12 and each of the first cushions 40 abuts the trunk 14 of the tree 16 when the first shells 12 are positioned around the trunk 14 of the tree 16. Each of the first cushions 40 extends between the first end 20 and the second end 22 of the respective first shell 12. Each of the first cushions 40 is comprised of a resiliently compressible material such as foam rubber or the like. Each of the first cushions 40 has a thickness that is sufficient to accommodate variations in the trunk 14 of the tree 16 thereby ensuring that no gaps exist between the first cushions 40 and the trunk 14 of the tree 16.

A pair of second shells 42 is provided and of the second shells 42 is removably attached together to form a closed ring. In this way each the second shells 42 can be positioned around the trunk 14 of the tree 16. Each of the second shells 42 has a primary end 44, a secondary end 46 and an outside surface 48 extending therebetween, and each of the second shells 42 has a front edge 50 and a back edge 52 each extending between the primary end 44 and the secondary end 46. Additionally, each of the second shells 42 is curved between the primary end 44 and the secondary end 46 such that each of the second shells 42 forms a semi-circle.

The outside surface 48 has top side 54 and the top side 54 of the outside surface 48 of each of the second shells 42 is convexly arcuate between the front edge 50 and the back edge 48 of the second shells 42. Each of the primary end 44 and the secondary end 46 of each of the second shells 42 abuts each other to form the closed ring. In this way the second shells 42 can be positioned around the trunk 14 of the tree 16 having each of the second shells 42 being positioned above the pair of first shells 12. Thus, the second shells 42 inhibit leaves or other particles from filling the first shells 12 and potentially forming a bridge across which the insects could cross the first shells 12.

A pair of second receivers 56 is each coupled to the primary end 44 of a respective one of the second shells 42. A pair of second ratchets 58 is each coupled to the secondary end 46 of a respective one of the second shells 42. Each of the second ratchets 58 has a distal end 60 with respect to the secondary end 46 of the respective second shell 42. Additionally, each of the second ratchets 58 has a plurality of teeth 62 extending between the distal end 60 and the secondary end 46 of the respective second shell 42. Each of the second receivers 56 insertably receives a respective one of the second ratchets 58. Moreover, a respective one of the teeth 62 on each of the second ratchets 58 engages a respective second receiver 56 thereby facilitating an adjustable diameter of the closed ring formed by the second shells 42. In this way the second shells 42 can accommodate a variety of sizes of trunks 14.

A pair of second cushions 64 is each coupled to a respective one of the second shells 42. Each of the second cushions 64 is aligned with the front edge 26 of the respective second shell 42 to abut the trunk 14 of the tree 16 when the second shells 42 are positioned around the trunk 14 of the tree 16. Moreover, each of the second cushions 64 extends between the primary end 44 and the secondary end 46 of the respective second shell 42.

In use, each of the first shells 12 is positioned around the trunk 14 of the tree 16 such that each of the first ratchets 34 engages a respective one of the first receivers 32. Thus, the first shells 12 form a closed ring extending around the trunk 14 of the tree 16. Each of the first shells 12 is subsequently filled with water 18 thereby inhibiting crawling insects from being able to cross the first shells 12. In this way the first shells 12 inhibit the crawling insects from climbing the trunk 14 of the tree 16. Each of the second shells 42 is positioned around the trunk 14 of the tree 16 such that each of the second ratchets 58 engages a respective one of the second receivers 56. Thus, the second shells 42 form a closed ring around the tree 16. Additionally, the second shells 42 are positioned above the first shells 12 on the trunk 14 of the tree 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An insect barrier assembly for positioning around a trunk of a tree to inhibit crawling insects from climbing the trunk, said assembly comprising:
a pair of first shells each being removably attached together to form a closed ring wherein each said first shells is configured to be positioned around a trunk of a tree, each of said first shells being concavely hollow thereby facilitating each of said first shells to be fillable with water wherein said first shells are configured to inhibit crawling insects from crossing said first shells and subsequently climbing the trunk of the tree; and
a pair of second shells each being removably attached together to form a closed ring wherein each said second shells is configured to be positioned around the trunk of the tree.

2. The assembly according to claim 1, wherein each of said first shells has a first end, a second end and an outer surface extending therebetween, each of said first shells having a front edge and a back edge each extending between said first end and said second end, each of said first shells being curved between said first end and said second end such that each of said first shells forms a semi-circle.

3. The assembly according to claim 2, wherein said outer surface has top side, said top side of said outer surface of each of said first shells being concavely arcuate between said front edge and said back edge, each of said first end and said second end of each of said first shells abutting each other to form said closed ring thereby facilitating said first shells to be positioned around the trunk of the tree.

4. The assembly according to claim 2, further comprising a pair of first receivers, each of said first receivers being coupled to said first end of a respective one of said first shells.

5. The assembly according to claim 4, further comprising a pair of first ratchets, each of said first ratchets being coupled to said second end of a respective one of said first shells, each of said first ratchets having a distal end with respect to said second end of said respective first shell, each of said first ratchets having a plurality of teeth extending between said distal end and said second end of said respective first shell, each of said first receivers insertably receiving a respective one of said first ratchets such that a respective one of said teeth on each of said first ratchets engages a respective first receiver thereby facilitating an adjustable diameter of said closed ring formed by said first shells wherein said first shells are configured to accommodate a variety of sizes of trunks.

6. The assembly according to claim 2, further comprising a pair of first cushions, each of said first cushions being coupled to a respective one of said first shells, each of said first cushions being aligned with said front edge of said respective first shell wherein each of said first cushions is configured to abut the trunk of the tree when said first shells are positioned around the trunk of the tree, each of said first cushions extending between said first end and said second end of said respective first shell.

7. The assembly according to claim 1, wherein each of said second shells has a primary end, a secondary end and an outside surface extending therebetween, each of said second shells having a front edge and a back edge each extending between said primary end and said secondary end, each of said second shells being curved between said primary end and said secondary end such that each of said second shells forms a semi-circle.

8. The assembly according to claim 8, wherein said outside surface has top side, said top side of said outside surface of each of said second shells being convexly arcuate between said front edge and said back edge of said second shells, each of said primary end and said secondary end of each of said second shells abutting each other to form said closed ring thereby facilitating said second shells to be positioned around the trunk of the tree having each of said second shells being positioned above said pair of first shells.

9. The assembly according to claim 7, further comprising:
a pair of first receivers; and
a pair of second receivers, each of said second receivers being coupled to said primary end of a respective one of said second shells.

10. The assembly according to claim 9, further comprising:
a pair of first ratchets; and
a pair of second ratchets, each of said second ratchets being coupled to said secondary end of a respective one of said second shells, each of said second ratchets having a distal end with respect to said secondary end of said respective second shell, each of said second ratchets having a plurality of teeth extending between said distal end and said secondary end of said respective second shell, each of said second receivers insertably receiving a respective one of said second ratchets such that a respective one of said teeth on each of said second ratchets engages a respective second receiver thereby facilitating an adjustable diameter of said closed ring formed by said second shells wherein said second shells are configured to accommodate a variety of sizes of trunks.

11. The assembly according to claim 7, further comprising:
a pair of first cushions: and
a pair of second cushions, each of said second cushions being coupled to a respective one of said second shells, each of said second cushions being aligned with said front edge of said respective second shell wherein each of said second cushions is configured to abut the trunk of the tree when said second shells are positioned around the trunk of the tree, each of said second cushions extending between said primary end and said secondary end of said respective second shell.

12. An insect barrier assembly for positioning around a trunk of a tree to inhibit crawling insects from climbing the trunk, said assembly comprising:
a pair of first shells each being removably attached together to form a closed ring wherein each said first shells is configured to be positioned around a trunk of a tree, each of said first shells being concavely hollow thereby facilitating each of said first shells to be fillable with water wherein said first shells are configured to inhibit crawling insects from crossing said first shells and subsequently climbing the trunk of the tree, each of said first shells having a first end, a second end and an outer surface extending therebetween, each of said first shells having a front edge and a back edge each extending between said first end and said second end, each of said first shells being curved between said first end and said second end such that each of said first shells forms a semi-circle, said outer surface having top side, said top side of said outer surface of each of said first shells being concavely arcuate between said front edge and said back edge, each of said first end and said second end of each of said first shells abutting each other to form said closed ring thereby facilitating said first shells to be positioned around the trunk of the tree;
a pair of first receivers, each of said first receivers being coupled to said first end of a respective one of said first shells;
a pair of first ratchets, each of said first ratchets being coupled to said second end of a respective one of said first shells, each of said first ratchets having a distal end with respect to said second end of said respective first shell, each of said first ratchets having a plurality of teeth extending between said distal end and said second end of said respective first shell, each of said first receivers insertably receiving a respective one of said first ratchets such that a respective one of said teeth on each of said first ratchets engages a respective first receiver thereby facilitating an adjustable diameter of said closed ring formed by said first shells wherein said first shells are configured to accommodate a variety of sizes of trunks;
a pair of first cushions, each of said first cushions being coupled to a respective one of said first shells, each of said first cushions being aligned with said front edge of said respective first shell wherein each of said first cushions is configured to abut the trunk of the tree when said first shells are positioned around the trunk of the tree, each of said first cushions extending between said first end and said second end of said respective first shell;
a pair of second shells each being removably attached together to form a closed ring wherein each said second shells is configured to be positioned around the trunk of the tree, each of said second shells having a primary end, a secondary end and an outside surface extending therebetween, each of said second shells having a front edge and a back edge each extending between said primary end and said secondary end, each of said second shells being curved between said primary end and said secondary end such that each of said second shells forms a semi-circle, said outside surface having top side, each said top side of said outside surface of each of said second shells being convexly arcuate between said front edge and said back edge of said second shells, each of said primary end and said secondary end of each of said second shells abutting each other to form said closed ring thereby facilitating said second shells to be positioned around the trunk of the tree having each of said second shells being positioned above said pair of first shells;
a pair of second receivers, each of said second receivers being coupled to said primary end of a respective one of said second shells;
a pair of second ratchets, each of said second ratchets being coupled to said secondary end of a respective one of said second shells, each of said second ratchets having a distal end with respect to said secondary end of said respective second shell, each of said second ratchets having a plurality of teeth extending between said distal end and said secondary end of said respective second shell, each of said second receivers insertably receiving a respective one of said second ratchets such that a respective one of said teeth on each of said second ratchets engages a respective second receiver thereby facilitating an adjustable diameter of said closed ring formed by said second shells wherein said second shells are configured to accommodate a variety of sizes of trunks;
a pair of second cushions, each of said second cushions being coupled to a respective one of said second shells, each of said second cushions being aligned with said front edge of said respective second shell wherein each of said second cushions is configured to abut the trunk of the tree when said second shells are positioned around the trunk of the tree, each of said second cushions extending between said primary end and said secondary end of said respective second shell.
